(19) United States
(12) Patent Application Publication
(10) Pub. No.: US 2006/0063480 A1
(43) Pub. Date: Mar. 23, 2006

(54) Air vent, in particular for a vehicle

(75) Inventors: Skadi Neumann, Selb (DE); Bernd Ehlers, Kulmbach (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Electronics & Components GmbH & Co. KG

(21) Appl. No.: 11/226,138

(22) Filed: Sep. 14, 2005

(30) Foreign Application Priority Data
Sep. 17, 2004 (DE) 20 2004 014 490.5

(51) Int. Cl. B60H 1/34

(52) U.S. Cl. 454/152

(57) ABSTRACT

An air vent, in particular for a vehicle, includes at least one adjustable vane (13) and a friction member (20), the friction member (20) being associated with the at least one adjustable vane (13) and the friction member (29) opposing friction to a movement of the vane (13).

### TECHNICAL FIELD

The invention relates to an air vent, in particular for a vehicle.

### BACKGROUND OF THE INVENTION

Such air vents are known in a variety of designs. In general, they serve to adjust in the desired manner the volume and the direction of an air flow supplied to a vehicle interior for air conditioning purposes. Customary components are adjustable vanes by means of which the air flow may be deflected.

In air vents known, the vanes may unintentionally move on account of vibrations during driving. This is undesirable.

It is the object of the invention to create an air vent that ensures that the vanes are fixed, so that an unintentional shifting of the vanes is prevented.

### BRIEF SUMMARY OF THE INVENTION

This is achieved in an air vent, in particular for a vehicle, including at least one adjustable vane and a friction member, the friction member being associated with the at least one adjustable vane and the friction member opposing friction to a movement of the vane. The advantages achieved with the invention consist in particular in the fact that the position of the vanes desired by the vehicle occupant is maintained even in the case of vibrations during driving. It is also possible at a small expenditure to adjust the operating force of the vanes to a desired value.

Preferably, a bearing part and a pin is provided, the vane being attached to the bearing part via the pin. The pin permits an easy, subsequent assembly of the vane.

The friction element may engage the pin. Thereby, a subsequent assembly is made possible.

Preferably, the friction element is firmly connected to the bearing part. The integral design permits a quick and thus inexpensive assembly on site.

Preferably, a housing and a recess are provided, the recess being formed wedge-shaped and being located in the housing and the friction element being located in the recess. On account of the recess being integrated in the housing, an additional component and an attachment thereof to the housing may be eliminated.

The friction element is preferably designed as a clamp which comprises free ends, the free ends resting against the recess and being compressed. A constant force introduction is made possible by compressing the ends of the clamp. Moreover, the desired pretensioning force may be generated at a small expenditure during assembly.

Preferably, an operating element is provided that engages the vane communicating with the friction element. Thus, a direct force introduction is possible, and any play in the coupling of the vanes among themselves is not perceived.

### BRIEF DESCRIPTION OF THE DRAWINGS

FIG. 1 shows a perspective view of an air vent in accordance with the invention in a first embodiment,

FIG. 2 shows an enlarged section of the region designated with X in FIG. 1 of the air vent,

FIG. 3 shows a schematic view of the region designated with X in FIG. 1 of the air vent, and

FIG. 4 shows a perspective view of the air vent in a second embodiment.

### BRIEF DESCRIPTION OF THE PREFERRED EMBODIMENTS

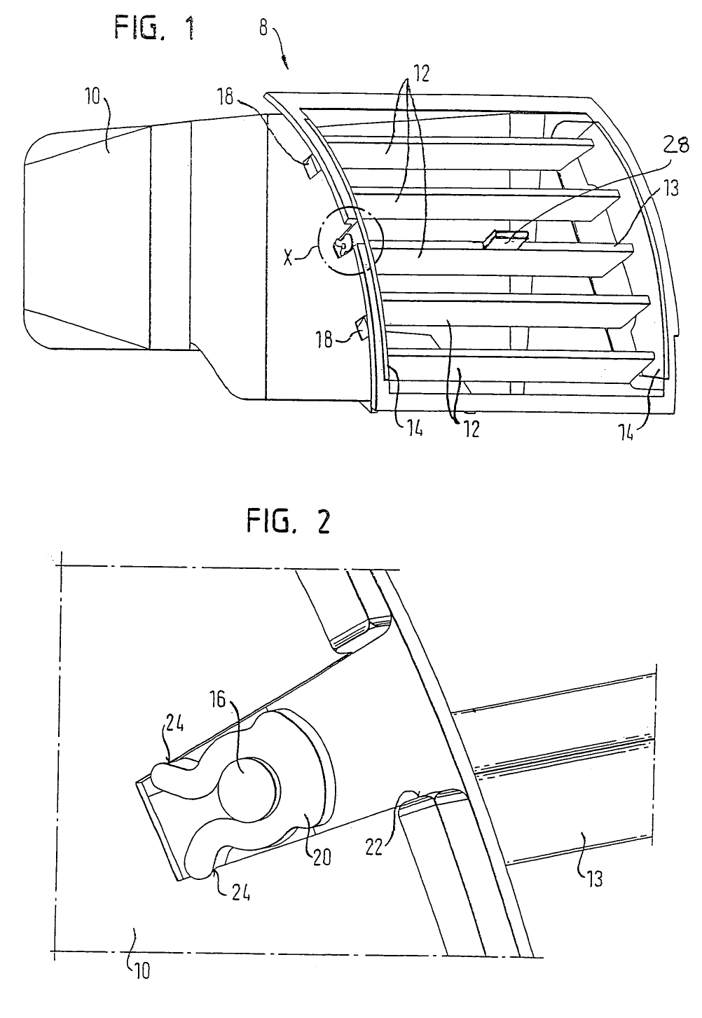

FIG. 1 shows an air vent 8. The air vent 8 includes a housing 10. The part of the housing 10 visible to the vehicle occupant is rectangular; it may, however, also be configured to be round (FIG. 4).

The air vent 8 comprises several vanes 12, 13. FIG. 1 shows five vanes 12, 13 which are arranged in parallel to each other and horizontally.

The air vent 8 includes bearing parts 14 which are disposed at opposite edges of the housing 10 and are secured to the housing 10 by means of latching elements 18. The bearing parts 14 conform to the shape of the housing 10; in this embodiment they are configured in a curved shape.

The vanes 12, 13 are attached to the bearing parts 14. The vanes 12, 13 include two pins 16 each which are arranged at the opposite ends of the vanes 12, 13 and engage in corresponding recesses of the bearing parts 14.

One of the vanes 12, 13 is connected in a known manner to an operating element 28 and provided with the reference number 13. This vane 13 likewise comprises two opposite pins 16. A friction element 20 (FIG. 2) engages one of the pins 16; in fact, the friction element 20 engages one vane 13. In this embodiment, the friction element 20 is formed integrally with the bearing part 14, it may, however, also be attached subsequently to the bearing part 14. The friction element 20 is configured as a clamp and is a spring element made of plastic material.

The friction element 20 is disposed in a recess 22 of the housing 10 that is configured to be wedge-shaped. The friction element 20 is compressed at the free ends by the converging recess 22. The friction element 20 comprises a groove 24. The groove 24 is arranged at least in the region of the ends that support on the recess 22 of the housing 10. The groove 24 enables the friction element to be safely attached to the recess 22 of the housing 10, since the edges of the friction element 20 project over the recess 22. Thus, the position may safely be maintained.

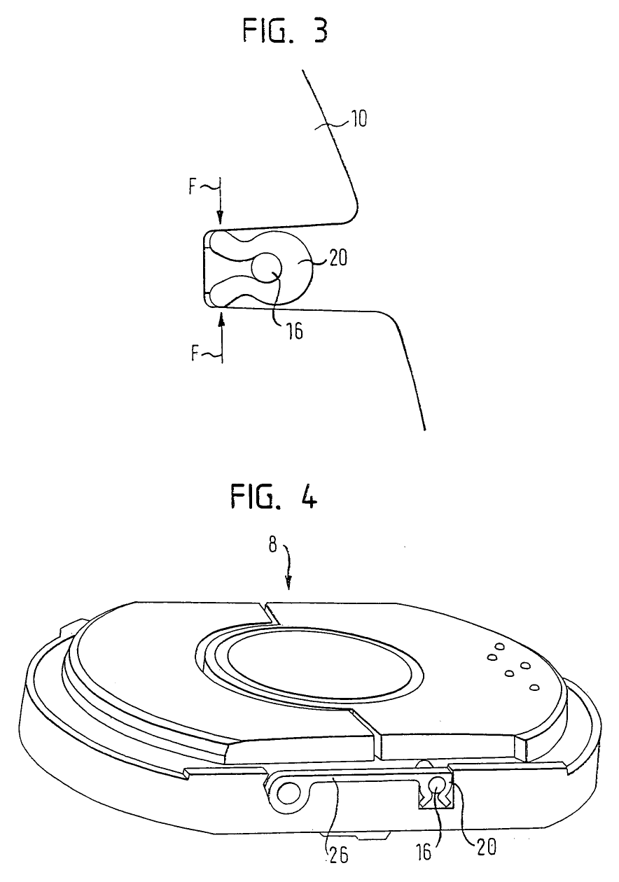

Compressing the ends of the friction element 20 by the housing 10 is accomplished by a force F (FIG. 3) that is transmitted to the pin 16 which is connected to the vane 13. The frictional force also exists when the operating element 28 is not rotated. Thus, the position of the vane 13, which is connected to the other vanes 12 via a connecting rod already known (not shown), is fixed in anyone position, and an unintentional shifting may be prevented.

FIG. 4 shows the arrangement of the friction element 20 in a round air vent 8. The friction element 20 is likewise connected via one of the pins 16 to the vane 13. In this arrangement, the friction element 20 includes an assembly rod 26 that supports on the pin 16 of a second vane 12. Since the functioning of the friction element 20 is identical to that described above, it will not be explained here in more detail.

1. An air vent, in particular for a vehicle, said air vent including at least one adjustable vane (13) and a friction member (20), said friction member (20) being associated with said at least one adjustable vane (13) and said friction member (29) opposing friction to a movement of said vane (13).

2. The air vent according to claim 1, wherein a bearing part (14) and a pin are provided, said vane (13) being attached to said bearing part (14) via said pin (16).

3. The air vent according to claim 2, wherein said friction element (20) engages said pin (16).

4. The air vent according to claim 2, wherein said friction element (20) is attached to said bearing part (14).

5. The air vent according to claim 2, wherein said friction element (20) is firmly connected to said bearing part (14).

6. The air vent according to claim 1, wherein said friction element (20) is configured as a spring element.

7. The air vent according to claim 1, wherein a housing (10) and a recess (22) are provided, said recess (22) being formed wedge-shaped and being located in said housing (10) and said friction element (20) being located in said recess (22).

8. The air vent according to claim 7, wherein said friction element (20) is configured as a clamp which comprises free ends, said free ends resting against said recess (22) and being compressed.

9. The air vent according to claim 1, wherein an operating element (28) is provided that engages said vane (13) communicating with said friction element (20).
